(19) United States
(12) Patent Application Publication
(10) Pub. No.: US 2007/0054095 A1
(43) Pub. Date: Mar. 8, 2007

(54) Gasket

(75) Inventor: Tadashi Kasuya, Utsunomiya-shi (JP)

Correspondence Address: KANESAKA BERNER AND PARTNERS LLP, 1700 DIAGONAL RD, SUITE 310, ALEXANDRIA, VA, 22314-2848, US

(73) Assignee: ISHIKAWA GASKET CO., LTD, Tokyo (JP)

(21) Appl. No.: 11/511,379

(22) Filed: Aug. 29, 2006

(30) Foreign Application Priority Data
Sep. 5, 2005 (JP) 2005-255901

(51) Int. Cl. B32B 3/00

(52) U.S. Cl. 428/172

(57) ABSTRACT

A gasket is formed of a metal plate, and includes a plurality of coating layers laminated on the metal plate. The coating layers may be a first coating layer laminated on the metal plate and at least one second coating layer laminated on the first laminating layer. An internal-layer confirmation portion is provided in a part of the second coating layer where the second coating layer is not formed so that presence or absence of the first coating layer is seen through the internal-layer confirmation portion.

### BACKGROUND OF THE INVENTION AND RELATED ART STATEMENT

The present invention relates to a gasket with multiple coatings on a metal substrate.

When the joint surfaces of a cylinder head and cylinder block (cylinder body) of an automobile engine are sealed, a metal cylinder head gasket is clamped between the cylinder head and cylinder block to seal combustion gas, coolant water, lubricating oil, and so on.

The above-mentioned cylinder head gasket is developed from the laminated type wherein a number of metal substrates are laminated, to a type with a simple constitution formed by one or two sheets of metal substrates, from the demand of a lightweight engine, a reduction in production costs, and so on. In this type of cylinder head gasket, the gasket is constituted by one or two sheets of metal substrates, and usable materials are limited with regard to a lightweight engine. Therefore, the type and number of sealing means are also limited, so that there is no choice but to use a relatively-simplified sealing means.

In a gasket with a few metal substrates, the role of a coating layer which is applied to the metal substrate becomes important. In one of the above-mentioned gaskets, a primer is applied on the metal substrate and a topcoat is applied on the primer. The primer-coated layer plays a role to be an adhesive for attaching the topcoat-coated layer to the metal substrate. Also, the topcoat-coated layer has appropriate hardness and elasticity, and generates appropriate sealing surface pressure.

In the gasket, in the case that only a topcoat layer is applied without a primer layer, the topcoat layer can easily come off since the adhesion to the metal substrate is insufficient. As a result, when the gasket is actually used, and a force acts after the gasket is soaked in an anti-freezing liquid or lubricating oil of the engine, an appropriate sealing effect cannot be provided. Therefore, confirmation of the presence or absence of the primer layer is important.

However, the difference between the presence and absence of the primer layer is indistinguishable from the appearance or hardness, so that even if an inferior product wherein the primer layer is not applied is found during the manufacturing process, once the topcoat layer is applied, the confirmation of the presence or absence of the primer layer cannot be easily made on the subsequent examination.

In order to solve the above-mentioned problem, when a soft material such as silicon rubber, fluorine rubber and so on is coated, the following coating methods on the surface of the gasket is proposed. A portion wherein only an appropriate coating layer is applied without recoating, i.e., a display coating layer is provided in the metal substrate relative to each coating layer in a state of being respectively spaced. Accordingly, the coating method can confirm whether or not there is an applied layer in the portion with eyes or by a reflective photo sensor and so on (for example, refer to Japanese Patent Publication No. H8-178074).

However, the display coating layer with a small surface area might come off during coating operations. Especially, when the coating layer on the surface side is laminated to the metal substrate as the adhesive of the coating layer on the internal side, the coating layer on the surface side has less force to adhere to the metal substrate. As a result, the display coating layer might come off during the coating operations of another coating layer or another process.

As far as the display coating layer comes off, in a structure of two-layered coatings, even if the display coating layer of the second coating layer on the surface side comes off, since the second coating layer becomes the surface, the presence or absence of the second coating layer can be visible. However, when the display coating layer of the first coating layer on the internal side comes off, the first coating layer is covered by the second coating layer, and becomes invisible. Therefore, the presence or absence of the first coating layer is invisible.

Especially, when the second coating layer is applied using the first coating layer on the internal side as a substitute for the adhesive, and a third coating layer on the surface side is additionally provided, the display coating layer of the second coating layer can easily come off. Once the display coating layer of the second coating layer comes off, the presence or absence of the second coating layer becomes invisible.

Also, in this structure, since the display coating layer with the small surface area is provided separately, a certain area is required. Accordingly, it is effective when the coating layer with a relatively small area such as only the periphery of a bore or see-through bore and so on is applied. When each coating layer is applied substantially to the whole metal substrate of the gasket, a place for providing the display coating layer becomes a problem.

On the other hand, as it is not a confirmation problem of the presence or absence of the internal layer of the recoating, a coat-state discriminating structure of the metal gasket is proposed by providing a small bore for coat-state discrimination in the metal gasket in order to confirm the displacement of the coat location during the time when a heat-resistant polymer material is coated into the depression of a bead after the coat is applied. The coat-state discriminating structure of the metal gasket detects and confirms the displacement between the coat and the bead from the displacement between the small bore and the coat coated around the small bore (for example, refer to Japanese Patent Publication No. 2002-81544).

However, in this structure, the small bore for coat-state discrimination is made for confirming the displacement of the coat being applied around the small bore, not made for confirming the laminated state, and is just a mark for positioning. Therefore, the small bore for the coat-state discrimination cannot be used for confirming the presence or absence of the coating layer on the internal side which is in a laminated state.

The present invention is made in order to solve the above-mentioned problems, and a purpose of the invention is to provide a gasket with multilayer coating layers for avoiding the problem of coming off which happens in the display coating layer, and to easily confirm whether or not the internal side is coated visually or by touch and so on.

Further objects and advantages of the invention will be apparent from the following description of the invention.

### SUMMARY OF INVENTION

In order to achieve the above-mentioned purpose, a gasket of the invention includes different kinds of coating layers laminated in a metal substrate. In a coating layer on the surface side, an internal-layer confirmation non-coating portion is provided in a part of a portion laminated in a coating layer on the internal side, and confirms the presence or absence of the coating layer on the internal side.

The different kinds of coating layers mean coating layers which can visually or optically acknowledge a difference by color, brightness, or gloss and so on, or by touch from the difference of materials. The different kinds of coating layers just need to differ from the adjacent coatings, and the same coating layer may be laminated by sandwiching another kind of coating layer.

The internal-layer confirmation non-coating portion is a portion which does not cover a part of the coating layer on the internal side provided in the coating layer on the surface side, and also the portion wherein a part of the coating layer on the internal side is exposed. The internal-layer confirmation non-coating portion can be formed by a bore which passes through the coating layer on the surface side, or when the gasket is looked at from a planar view, the end of the coating layer on the surface side can be formed by a displaced portion wherein a part of the end of the coating layer on the internal side is not covered.

According to the structure, the whole coating layer on the surface side is laminated to the coating layer on the internal side and applied, so that there is no possibility of coming off. Therefore, in the gasket manufactured through a multiple-coating process, the problem of coming off which happens in the case of a display coating layer can be prevented. Also, whether or not the internal side is coated can be reliably and easily confirmed visually or by touch and so on.

In the above-mentioned gasket, in the case of coating layers with more than three layers, the shape, size, and position of the internal-layer confirmation non-coating portion of each coating layer, except for the coating layer which is located on the innermost internal side, is made in such a way that a portion of each coating layer laminated sequentially on the internal side can be confirmed respectively from the internal-layer confirmation non-coating portion of the coating layer on the outermost surface side.

By this structure, even if the multiple coating layers have more than three layers, the presence or absence of each whole coating layer can be easily confirmed visually or by touch and so on.

In the above-mentioned gasket, the internal-layer confirmation non-coating portion is located near the place where an imprint of the gasket is made. Due to this structure, when the imprint is applied, or when the imprint is examined or confirmed, since there is the internal-layer confirmation non-coating portion within sight, the presence or absence of the coating layer can be confirmed simultaneously with an examination of the imprint.

Also, it is preferred that the internal-layer confirmation non-coating portion is located in a portion which does not affect the sealing effect and so on of the gasket even if there is no coating layer on the surface side. Even from this aspect, the location wherein the seal is impressed becomes an appropriate place.

In addition, in the case that exposing the coating layer on the internal side is undesirable, the internal-layer confirmation non-coating portion is covered by a transparent or half-transparent coating agent which is different from the coating layer on the surface side, so that the coating layer on the internal side is prevented from being exposed.

According to the gasket of the invention, in a gasket manufactured through the multiple-coating process, the problem of coming off which happens in the case of the display coating layer can be prevented, and whether or not the internal side is coated can be easily confirmed visually or by touch and so on.

### BRIEF DESCRIPTION OF THE DRAWINGS

FIG. 1 is a plan view showing a portion of a cylinder head gasket of the first embodiment according to the present invention;

FIG. 2 is a partial perspective view showing an internal-layer confirmation non-coating portion including a partial cross-sectional surface of the first embodiment according to the present invention;

FIG. 3 is a partial perspective view showing the internal-layer confirmation non-coating portion including a partial cross-sectional surface of the second embodiment according to the present invention;

FIG. 4 is a plan view showing a portion of the cylinder head gasket of the third embodiment according to the present invention;

FIG. 5 is a partial perspective view showing the internal-layer confirmation non-coating portion of the third embodiment according to the present invention; and

FIG. 6 is a partial perspective view showing the internal-layer confirmation non-coating portion of the fourth embodiment according to the present invention.

### DETAILED DESCRIPTION OF PREFERRED EMBODIMENTS

Hereinafter, embodiments of gaskets of the present invention will be explained with a cylinder head gasket used for an engine as an example with reference to the drawings.

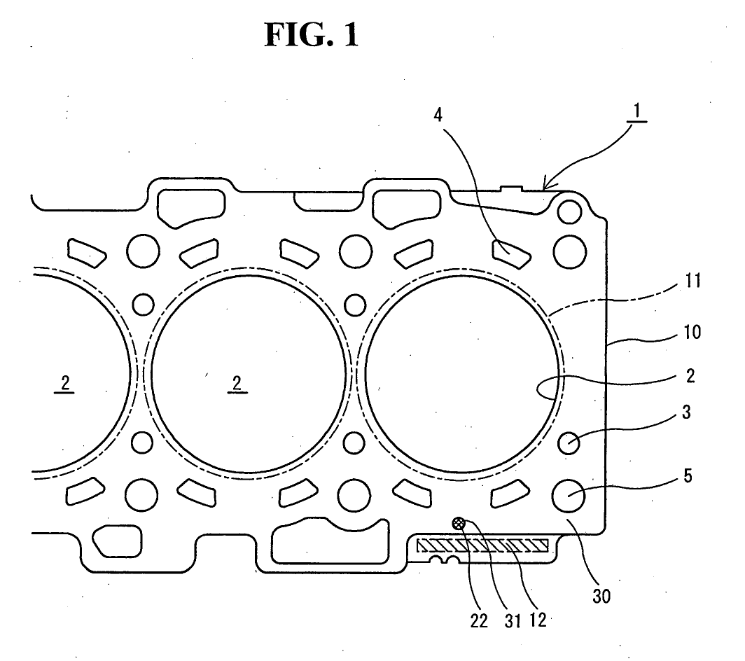

Cylinder head gaskets 1, 1A, 1B, 1C of the embodiments of the present invention shown in FIGS. 1-6 are metal gaskets clamped between the cylinder head and cylinder block (cylinder body) of an engine to seal high-temperature and high-pressure combustion gas in a cylinder bore, and liquid such as coolant water or oil and so on in a coolant-water passage or cooling-oil passage and so on.

Incidentally, FIGS. 1-6 are pattern explanatory drawings, and horizontal to vertical ratios and so on in cross-sectional surfaces of metal-laminate gaskets 1, 1A, 1B, 1C are shown differently from actual ratios in order to make them easily understood.

First, the cylinder head gaskets will be explained. As shown in FIG. 1, the cylinder head gasket 1 of the embodiment is constituted by a single sheet of metal substrate 10. The metal substrate 10 is formed by stainless annealed material (anneal material) or a mild steel plate and so on, and manufactured in accordance with the shape of an engine member such as a cylinder block and so on.

In the metal substrate 10, cylinder bores 2, water holes 3 for the coolant water, oil holes 4 for the circulation of engine oil, tightening bolt holes 5 for tightening bolts and so on are formed. Also, beads 11 formed by full beads are provided around each cylinder bore 2 as a sealing means respectively. The beads 11 surround the cylinder bores 2 respectively.

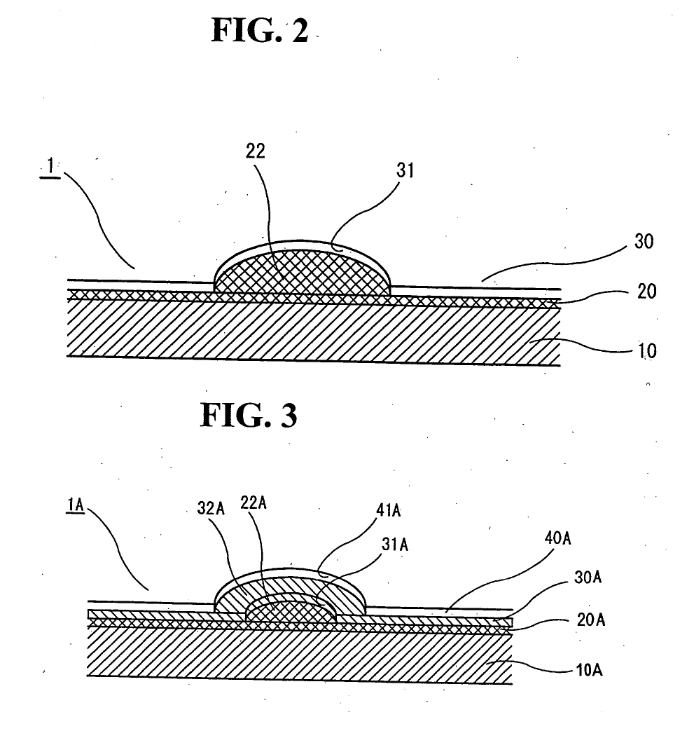

In the first embodiment, as shown in FIGS. 1, 2, a first coating layer 20 is applied to the metal substrate 10 of the cylinder head gasket 1, and a second coating layer 30 is applied on the surface side of the first coating layer 20. More specifically, different kinds of coating layers 20, 30 are laminated in the metal substrate 10.

This first coating layer 20 is also called a primer coating layer, made from a material such as epoxy, phenol, phenoxy and so on, and laminated in such a way that the thickness of the first coating layer 20 becomes approximately 5μ-10μ. The first coating layer 20 serves as an adhesive between a surface rubber layer and metal.

A second coating layer 30 is also called a topcoat coating layer, made from a material such as fluorine, NBR, silicone and so on, and laminated in such a way that the thickness of the second coating layer 30 becomes approximately 10μ-20μ. The second coating layer 30 strengthens the sealing performance of the gasket by fitting to an engine tool mark.

Since the first coating layer 20 and second coating layer 30 have different color, brightness, gloss, touch and so on, they can be distinguishable visually (optically) or even by touch.

The second coating layer 30 on the surface side includes an internal-layer confirmation non-coating portion 31 for confirming the presence or absence of the first coating layer 20 on the internal side. The internal-layer confirmation non-coating portion 31 is a portion which does not cover a part of the first coating layer 20 on the internal side provided in the second coating layer 30 on the surface side.

The internal-layer confirmation non-coating portion 31 is formed by a through hole (peephole) 31 which passes through the second coating layer 30 on the surface side. The through hole 31 is formed in such a way that a portion 22 of the first coating layer 20 on the internal side can be observed from the through hole 31. Usually, if there is one internal-layer confirmation non-coating portion 31, an operational effect can be accomplished. However, multiple internal-layer confirmation non-coating portions 31 may be provided.

If the internal-layer confirmation non-coating portion 31 is provided near a place 12 where the imprint of the manufacturer's serial number or date of manufacture and so on of the gasket 1 is provided, when the imprint is made, or the imprint is examined or confirmed, since there is the internal-layer confirmation non-coating portion 31 within sight, the presence or absence of the coating layer 20 on the internal side can be confirmed simultaneously with an examination of the imprint.

Next, the gasket with more than three layers will be explained as a second embodiment. As shown in FIG. 3, in the gasket 1A, the first coating layer 20A is applied to the metal substrate 10, the second coating layer 30A is applied to the surface side of the first coating layer 20A, and the third coating layer 40A is applied to the surface side of the second coating layer 30A. More specifically, different kinds of coating layers 20A, 30A, 40A are laminated in the metal substrate 10.

These first, second, and third coating layers 20A, 30A, 40A have different color, brightness, gloss, touch and so on, so that they can be distinguishable visually or even by touch.

In the gasket 1A, the internal-layer confirmation non-coating portion 31A for confirming the presence or absence of the first coating layer 20A on the internal side is provided in the second coating layer 30A of the inner layer. The internal-layer confirmation non-coating portion 31A is a portion which does not cover a portion 22A of the first coating layer 20A on the internal side provided in the second coating layer 30A of the inner layer, and formed by a through hole 31A which passes through the second coating layer 30A of the internal layer. The portion 22A of the first coating layer 20A on the internal side can be observed from the through hole 31A.

In the case of a three-layered lamination structure, an internal-layer confirmation non-coating portion 41A for confirming the presence or absence of the second coating layer 30A of the inner layer is additionally provided in the third coating layer 40A on the surface side. The internal-layer confirmation non-coating portion 41A is a portion which does not cover a portion 32A of the second coating layer 30A of the inner layer provided in the third coating layer 40A on the surface side, and formed by a through hole 41A which passes through the third coating layer 40A on the surface side. The portion 32A of the second coating layer 20A of the inner layer and at least one part of the through hole 31A can be observed from the through hole 41A. Also, the portion 22A of the first coating layer 20A can be observed from at least a part of the through hole 31A.

More specifically, the opening area of the internal-layer confirmation non-coating portion 41A of the coating layer 40A on the outermost surface side (non-coating area) is made the widest, and as the layers go to the internal side, the opening areas of the internal-layer confirmation non-coating portions 41A, 31A of the coating layers 40A, 30A become smaller sequentially. Also, if the internal-layer confirmation non-coating portions 41A, 31A are concentrically provided, the processing becomes easier. However, they are not necessarily required to be a circular form, and centers of the opening areas are not also required correspondingly. The portions 32A, 22A of the coating layers 30A, 20A on the internal side are only required to be seen respectively.

In other words, when the coating layers 40A, 30A, 20A have more than three layers, shapes, sizes, and positions of the internal-layer confirmation non-coating portions 41A, 31A of each coating layer 40A, 30A, except for the coating layer 20A which is located on the innermost internal side, are made in such a way that the portions 32A, 22A of the coating layers 30A, 20A laminated sequentially to the internal side can be confirmed from the internal-layer confirmation non-coating portion 41A of the coating layer 40A on the outermost surface side. Due to this structure, even if the coating layers 40A, 30A, 20A have more than three layers, the presence or absence of each coating layer 30A, 20A on the internal side can be reliably and easily confirmed visually or by touch and so on.

Also, the internal-layer confirmation non-coating portions 31A, 41A are provided near the place where the imprint of the manufacturer's serial number or date of manufacture and so on of the gasket 1A is made, when the imprint is made, or the imprint is examined or confirmed, since there are internal-layer confirmation non-coating portions 31A, 41A within sight, the presence or absence of the coating layers 20A, 30A can be confirmed simultaneously with the examination of the imprint.

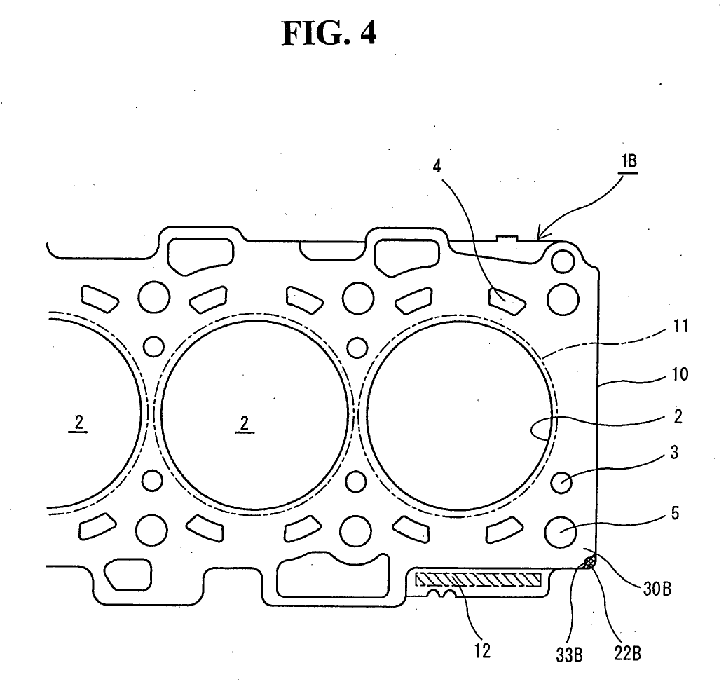

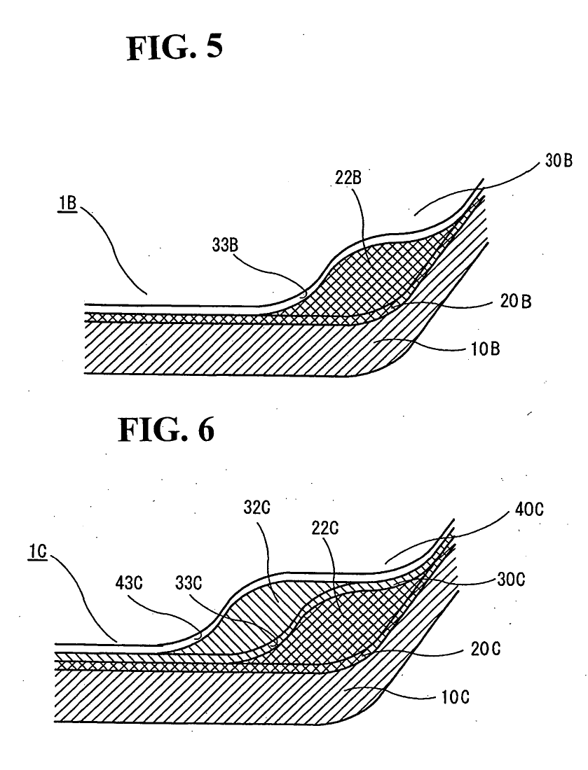

The cylinder head gasket 1B of the third embodiment will be explained. As shown in FIGS. 4, 5, in the cylinder head gasket 1B, instead of forming the internal-layer confirmation non-coating portion by the through hole 31 of the first embodiment, the end of the second coating layer 30B on the surface side is formed by providing a displacement 33B which does not cover the portion 22B of the end of a first coating layer 20B on the internal side. Preferably, this internal-layer confirmation non-coating portion 33B is provided near the place 12 where the imprint of the manufacturer's serial number or date of manufacture and so on of the gasket 1B is formed.

The displacement 33B includes the same function as the through hole 31 of the cylinder head gasket 1 of the first embodiment, and can have the same operational effect.

The cylinder head gasket 1C of the fourth embodiment will be explained. As shown in FIG. 6, in the cylinder head gasket 1C, instead of forming the internal-layer confirmation non-coating portion by the through holes 41A, 31A of the second embodiment, the end of a second coating layer 30C is formed by providing a displacement 33C which does not cover a portion 22C of the end of a first coating layer 20C on the internal side. Moreover, the end of a third coating layer 40C on the surface side is formed by providing a displacement 43C which does not cover a portion 32C of the end of the second coating layer 30C on the internal side. At the same time, the displacement 43C is formed in such a way that the displacement 43C does not also cover the portion 22C of the end of the first coating layer 20C on the internal side.

Even in the fourth embodiment, the non-coating area of the internal-layer confirmation non-coating portion 43C of the coating layer 40C which is located on the outermost surface side is made the widest. As the layers go to the internal side, the non-coating areas of the internal-layer confirmation non-coating portions 43C, 33C of the coating layers 40C, 30C become smaller sequentially. Also, in the internal-layer confirmation non-coating portions 43C, 33C, the portions 32C, 22C of the coating layers 30C, 20C on the internal side all just have to be visible. Preferably, these internal-layer confirmation non-coating portions 33C, 43C are provided near the place where the imprint of the manufacturer's serial number or date of manufacture and so on of the gasket 1C is formed.

These displacements 43C, 33C include the same function with the through holes 41A, 31A of the cylinder head gasket 1A of the second embodiment, and can have the same operational effect.

According to the structure of the gasket 1 (1A; 1B; 1C) of the first-fourth embodiments, even if the multiple coating layers have more than three layers, the whole coating layer 30 (40A, 30A; 30B; 40C, 30C) on the surface side is laminated to the coating layer 20 (30A, 20A; 20B; 30C, 20C) on the internal side, so that there is no possibility of coming off. Therefore, in the gasket 1 (1A; 1B; 1C) manufactured through the multiple-coating process, whether or not the coating layer 20 (30A, 20A; 20B; 30C, 20C) on the internal side is applied can be easily confirmed visually or by touch and so on.

Also, if the internal-layer confirmation non-coating portion 31 (31A, 41A; 33B; 33C, 43C) is provided near the place 12 where the imprint of the gasket 1 (1A; 1B; 1C) is formed, when the imprint is made, or the imprint is examined or confirmed, since there is the internal-layer confirmation non-coating portion 31 (31A, 41A; 33B; 33C, 43C) within sight, the presence or absence of the coating layer 20 (30A, 20A; 20B; 30C, 20C) can be confirmed simultaneously with the examination of the imprint.

Incidentally, the above-mentioned embodiments are explained using the example of the single-metal cylinder head gasket formed by a single metal substrate. However, the present invention can be applied to a laminated-type metal cylinder head gasket where multiple sheets of metal substrates are laminated.

The disclosure of Japanese Patent Application No. 2005-255901 filed on Sep. 5, 2005 is incorporated as a reference.

While the invention has been explained with reference to the specific embodiments of the invention, the explanation is illustrative and the invention is limited only by the appended claims.

What is claimed is:

1. A gasket comprising:
a metal plate for constituting the gasket,
a plurality of coating layers laminated on the metal plate, and including a first coating layer laminated on the metal plate and at least one second coating layer laminated on the first laminating layer, and
an internal-layer confirmation portion provided in a part of the second coating layer where the second coating layer is not formed so that presence or absence of the first coating layer is seen through the internal-layer confirmation portion.

2. A gasket according to claim 1, wherein said internal-layer confirmation portion is a non-forming portion where the second coating layer is not formed so that the first coating layer is seen through the non-forming portion.

3. A gasket according to claim 2, further comprising a third coating layer laminated on the second coating layer, and having another non-forming portion greater than the non-forming portion at the second coating layer as said internal-layer confirmation portion.

4. A gasket according to claim 3, wherein said non-forming portion and another non-forming portion are at least partly overlapped.

5. A gasket according to claim 1, wherein said internal-layer confirmation portion is located near a place on the metal plate where an imprint of the gasket is formed.

6. A gasket according to claim 1, wherein said plurality of coating layers laminated together is different in color, brightness and gloss.
